(19) United States
(12) Patent Application Publication
(10) Pub. No.: US 2016/0111017 A1
(43) Pub. Date: Apr. 21, 2016

(54) VIRTUAL MIRROR SYSTEMS AND METHODS FOR REMOTELY TRAINING AND/OR SUPPORTING CONTACT LENS USERS

(71) Applicant: Johnson & Johnson Vision Care, Inc., Jacksonville, FL (US)

(72) Inventors: Wai Kiit Jack Chan, Jacksonville, FL (US); Junrong Chen, Jacksonville, FL (US); Kam Yee Karen Cheng, Jacksonville, FL (US); Chae Kwan Jay Lee, Jacksonville, FL (US)

(21) Appl. No.: 14/885,701

(22) Filed: Oct. 16, 2015

Related U.S. Application Data
(60) Provisional application No. 62/065,320, filed on Oct. 17, 2014.

(51) Int. Cl. G09B 19/00; G09B 5/04; G09B 5/06; G09B 5/02

(52) U.S. Cl. CPC G09B 19/003; G09B 5/02; G09B 5/04; G09B 5/06

(57) ABSTRACT

Systems and methods are provided to assist a user with contact lens usage. The system includes a virtualization apparatus on a communication device for use by the contact lens user. The virtualization apparatus includes a front mirror with optical sensor and a side mirror in reflective communication with another optical sensor. The mirrors reflect images of the contact lens user during a contact lens training and support session and the user communication device communicates with a remote trainer or compliance monitor. The method is directed to a trainer or compliance monitor remotely training or monitoring a contact lens user utilizing the systems in accordance with the principles of the invention.

### CROSS-REFERENCE TO RELATED APPLICATIONS

This application claims priority to U.S. Provisional Application No. 62/065,320 (filed on Oct. 17, 2014), the contents of which are incorporated by reference in their entirety.

### TECHNICAL FIELD

The present invention relates to systems and methods for remotely training and/or supporting contact lens users. More specifically, the invention is directed to virtual mirror systems and methods for contact lens training and/or support provided to contact lens users by trainers and other individuals who are remotely training and/or supporting the contact lens users.

### BACKGROUND OF THE INVENTION

The use of contact lenses has become increasingly popular in recent years due to improvements in lens technology as well as the feasibility of their use for aesthetic purposes. Additionally, the lower costs of contact lenses, and their availability from on-line, telephone and mail order retailers have made them more accessible to the average user. As a result, manufacturers are increasingly facing the challenge of teaching mass amounts of new users how to properly insert and remove their contact lenses. Additionally, monitoring the correct installation and removal procedures, as well as the frequency and duration of wear, presents a further challenge for assessing compliance and gathering data for product design and regulatory approval.

The process of inserting a contact lens typically includes the user positioning the lens on a finger of one hand and physically applying the lens onto the surface of the eye. For instance, the contact lens is typically removed from its packaging positioned on the index finger of one hand, and positioned onto the surface of the eye. The moist nature of the contact lens tends to adhere it to the user's finger and allows them to manipulate the contact lens from a horizontal and supported position to a substantially vertical position for application.

Thereafter, to remove the contact lens from the eye, the user will typically pinch or flex the contact lens between two opposing fingers to break the surface tension and suction adhering the contact lens to the user's eye. Once the contact lens is pinched or flexed, the user peals the lens off their eye with their fingers.

As evident by these procedures, the insertion and removal of the contact lens requires deliberate precise movements and a sense of spatial relations by the user in relation to the eye. Furthermore, it requires a certain amount of dexterity that is learned over a period of time. Any imprecision in movement by the user can result in severe discomfort. As such, new users of contact lenses often experience great difficulty in accurately inserting and removing the lenses.

Rarely have manufacturers developed processes for teaching new users how to insert and remove contact lenses. To attempt to provide personal instruction to new users, manufacturers would need to employ massive amounts of trainers located throughout the world. The costs of such would be prohibitive. Accordingly, systems and methods are needed for training new users of contact lenses in the proper techniques for their insertion and removal that can reach a geographically dispersed population in an economically feasible manner. Similarly, systems and methods are needed for monitoring use of correct insertion and removal procedures, as well as the frequency and duration of wear for users involved in studies to support product design, development and regulatory approval activities. The present invention provides such systems and methods.

### BRIEF SUMMARY OF THE INVENTION

In one aspect of the invention, a virtualization apparatus for assisting a user with contact lens usage is provided, including a front mirror having an opening. A support member is coupled to the front mirror. The front mirror by way of the support member is capable of being attached to a communication device. The opening of the front mirror is adapted to be aligned with an optical sensor of the communication device.

The virtualization apparatus also may include a side mirror coupled to the support member and adapted for positioning beyond and alongside the communication device. The side mirror is coupled to the support member by a support arm. At least one of the support arm and the side mirror of the virtualization apparatus is adjustable.

The virtualization apparatus also may include a rear mirror adapted to be coupled to the communication device proximate a second optical sensor on the communication device. The rear mirror is adapted to have a first reflective path between the rear mirror and the second optical sensor, and a second reflective path between the rear mirror and the side mirror. The support member extends outwardly and has a portion adapted to support the rear mirror and the rear mirror is attached to the portion of the support member.

The virtualization apparatus also may include both a side mirror and a rear mirror coupled to the support member, wherein the side mirror and the rear mirror are angled to reflect upon each other. The virtualization apparatus also may include a rear optical sensor. The side mirror and the rear mirror are adapted to be angled to reflectively communicate between the rear optical sensor and an object.

The virtualization apparatus may also include a support stand adapted to support the communication device and the front and side mirrors in a position to reflect on an object. The front mirror is adapted reflect a front view of the object and the side mirror is adapted to reflect a side view of the object. The object includes a contact lens during usage and an insertion device to support usage of the contact lens. The contact lens usage includes insertion and removal of the contact lens.

In another aspect of the invention, a system for assisting a user with contact lens usage is provided including a virtualization apparatus with a front mirror having an opening therein and a rear member outwardly extending from a back of the front mirror. A communication device is provided including at least an output device, a processor, and an optical sensor. A stand is configured to receive and hold the communication device substantially upright. The opening of the front mirror is adapted to be aligned with the optical sensor of the communication device and is adapted to be coupled to the communication device by the rear member. The processor of the communication device is configured to instruct the user how to use the contact lens through the output device of the communication device. The processor is configured to communicate with a remotely located communication device and is configured to instruct the user how to use the contact lens based upon at least input from the remote communication device.

The system may further include an attachment member extending from the rear member, and an elongated member having a first end attached to a first portion of the attachment member and a second end attached to a side mirror. The second end of the elongated member protrudes outwardly beyond the communication device. The system further may include a rear mirror attached a second portion of the attachment member. The side mirror and the rear mirror are adapted to reflect upon each other.

The system may also include an elongated attachment member fixed to an exterior of the rear member. The attachment member has a first end and an opposing second end. The first end is fixed to the bottom portion of the elongated member. A side mirror is attached to the second end of the attachment member and extends beyond the communication device. The rear member includes at least a first arm and an opposing second arm. The first arm and the opposing second arm extend from a bottom portion of the rear member, and each clip on to a respective front side and second side of the communication device. The processor of the communication device is configured to instruct through at least one of a visual cue, an audio cue and an instructional video. The system also includes a second communication device transmitting instructions to the communication device.

In another aspect of the invention, a system is provided for assisting a contact lens wearer with contact lens usage including a user communication device including an output device, a processor, and an optical sensor, and a virtualization apparatus coupled to the user communication device. The virtualization apparatus has a front mirror having an opening. The front mirror is coupled to the user communication device with the front mirror opening adapted for alignment with the optical sensor, whereby the front mirror and the optical sensor are directed in a direction toward the contact lens user and an image on the front mirror is substantially the same image sensed by the optical sensor. The processor is configured to communicate with a remote communication device, to communicate the image to the remote communication device and to receive instructions from the remote communication device regarding contact lens usage. The system may also have a side mirror adapted to be coupled to the user communication device having a second sensor, with the side mirror being adapted to be in reflective communication with the second sensor. The processor is configured to communicate information from the second sensor to the remote individual communication device. The system may further include a back mirror adapted to be in reflective communication with the side mirror and the second sensor. The output device is a display device and the image is displayed on the display device. The image of the system is a video image. The processor is configured to transmit the image to the remove communication device.

In another aspect of the invention, a system is provided for monitoring a contact lens wearer's insertion procedure, removal procedure, frequency of wear and/or duration of wear including a user communication device including an output device, a processor, and an optical sensor, and a virtualization apparatus coupled to the user communication device. The virtualization apparatus has a front mirror having an opening. The front mirror is coupled to the user communication device with the front mirror opening adapted for alignment with the optical sensor, whereby the front mirror and the optical sensor are directed in a direction toward the contact lens user and an image on the front mirror is substantially the same image sensed by the optical sensor. The processor is configured to communicate with a remote communication device, to communicate images and/or information concerning the user's contact lens insertion, wear and/or removal to the remote communication device.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The features and advantages of the invention will be apparent from the following drawings wherein like reference numbers generally indicate identical, functionally similar, and/or structurally similar elements.

FIG. 1 shows an embodiment of a virtual mirror system in accordance with the principles of the invention.

FIG. 2A shows another embodiment of a virtual mirror system in accordance with the principles of the invention.

FIG. 2B shows a perspective view of a portion of the virtual mirror system shown in FIG. 2A from another directional view in accordance with the principles of the invention.

FIG. 2C shows a perspective view of a virtualization apparatus of the type shown in FIG. 2A from another directional view and detached from the computing device.

FIG. 2D shows a top view of the system shown in FIG. 2A.

FIG. 3A shows another embodiment of a virtual mirror system in accordance with the principles of the invention.

FIG. 3B shows a top view of the system shown in FIG. 3A.

FIG. 3C shows another perspective view of the system shown in FIG. 3A.

FIG. 3D shows another perspective view of the system shown in FIG. 3A.

FIG. 4 shows a contact lens user using a system in accordance with the principles of the invention.

FIG. 5 shows another individual remotely located from the user and the remotely located individual has a communication device in communication with the system shown in FIG. 4.

FIG. 6 shows network and system components for use with various contact lens users utilizing the system showing in FIG. 3A and individuals and/or trainers with communication devices remotely located from the users, whereby a user and an individual and/or trainer remotely located have the capability of two-way communication in accordance with the principles of the invention.

FIG. 7 shows a schematic diagram of an exemplary processor that can be utilized in accordance with the principles of the invention.

### DETAILED DESCRIPTION

The systems and methods in accordance with the principles of the invention can be implemented for virtual training and/or monitoring of contact lens users in an individualized and personalized manner. With a trainer remotely located from the user, the systems and methods utilized can provide access to and viewing of the user through the virtual mirror system in accordance with the principles of the invention. The systems and methods can be implemented in a contact lens training situation as described herein, but are not limited to a contact lens user-trainer situation. In addition to trainers, any type of individual interacting remotely with a contact lens user in accordance with the principles of the invention can be contemplated, including, for example, individuals associated with contact lens education, compliance and follow-up.

Spatial and multi-dimensional access to and viewing of the contact lens user is provided through the use of the virtual mirror system, which includes mirrors arranged on a personal computing device in cooperation with optical sensors on the computing device. The arrangement and mounting of the mirrors on the computing device and in relation to the optical sensors, provides a remotely located trainer and contact lens user with an in-person-like contact lens training experience. Additionally, such an apparatus and system can provide information concerning the user's insertion, wear and removal of the lenses, including date and time of insertion, duration of wear, frequency of wear, video images of, insertion and removal procedures and images of the user's eyes at insertion and removal.

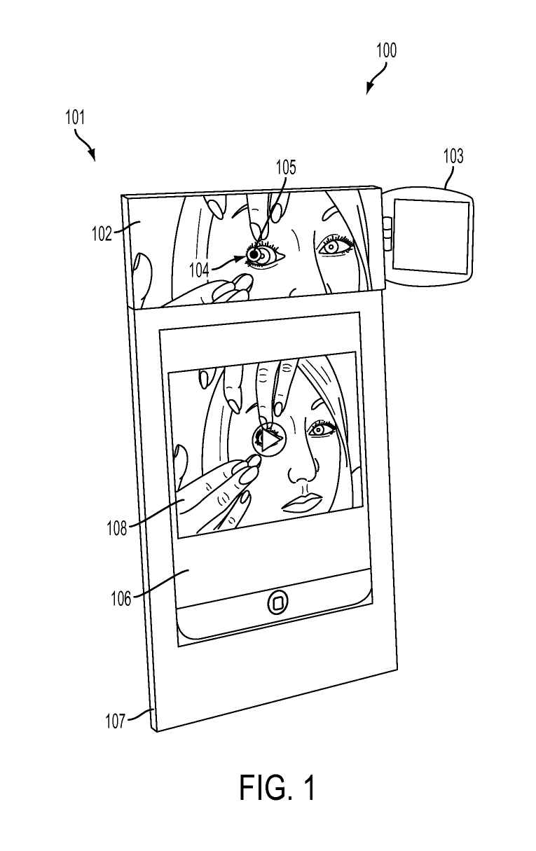

Referring now to the figures, various exemplary implementations of the virtual mirror systems and methods will be described. Referring to FIG. 1, a system shown generally at reference number 100 can be provided for use by the contact lens user. System 100, as shown, generally includes a communication device 106 with a stand 107 and a virtualization apparatus shown generally at 101.

Communication device 106 can include a device with a processor and an output or display device 108 operative to display output, including, displaying images including video. As shown, communication device 106 can be a modified conventional tablet computer configured to process image information in accordance with the principles of the invention. As shown, display device 108 can display a recorded video of the contact lens user, shown in the stopped position as indicated by the graphic representing “play”, which can be activated by a touch. The video can show a recording of the contact lens user during an insertion/removal process. The contact lens user can watch a self or a training video while inserting a lens in real-life in front of front mirror 102. Display device 108 can display other content as well. A video conference call can be displayed on display device 108 as described later, for example, with reference to FIGS. 4 and 5 to provide for remote training by a trainer. A stand 107 can be provided to support and position communication device 106 in an upright ergonomic position related to a contact lens user.

Coupled to communication device 106 is virtualization apparatus 101. Virtualization apparatus 101 can include a front mirror 102 that can be positioned to face the contact lens user. As shown, front mirror 102 can include an opening 104 that can align with an optical sensor 105 on communication device 106. Optical sensor 105 can be a conventional camera on a tablet computer. Front mirror 102 shows a reflection of a contact lens user. Optical sensor 105 is viewing and sensing a similar image as shown in front mirror 102. Information sensed by optical sensor 105 can be communicated to a remote location, such as a trainer or compliance monitor, as described later, for example, with reference to FIGS. 4 and 5. Information sensed by optical sensor 105 can be the contact lens user who is looking into the front mirror 102 to insert a contact lens. Accordingly, the remote trainer or compliance monitor can view the user inserting the contact lens and can see the same thing the user is seeing.

Virtualization apparatus 101 can also include side mirror 103 and associated components including another optical sensor (not shown, but shown and discussed in other embodiments) to reflect, record and communicate images between the contact lens user and a remote trainer or compliance monitor.

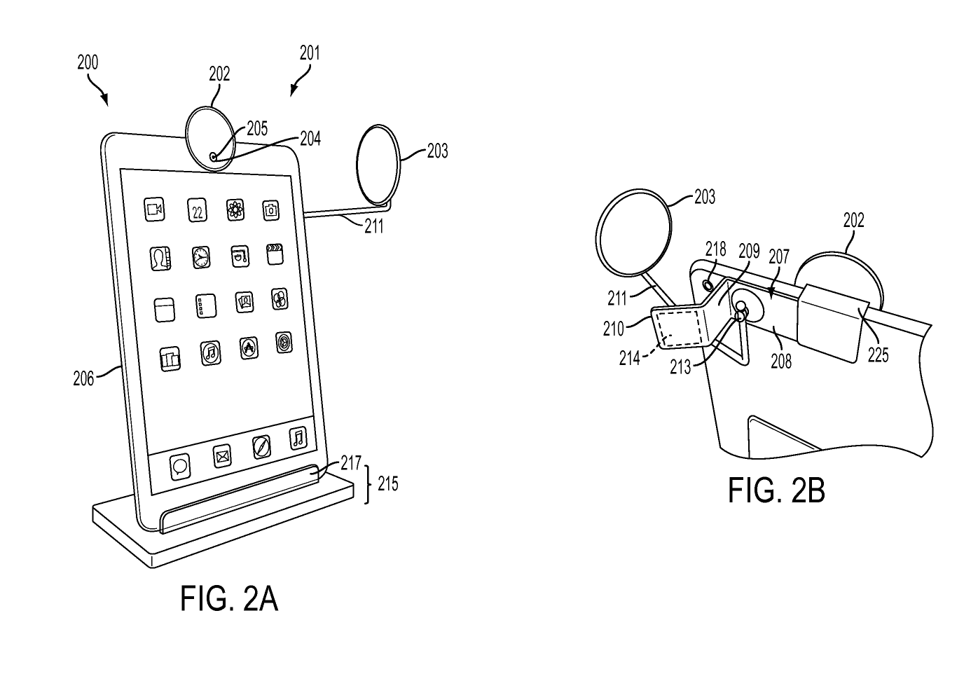

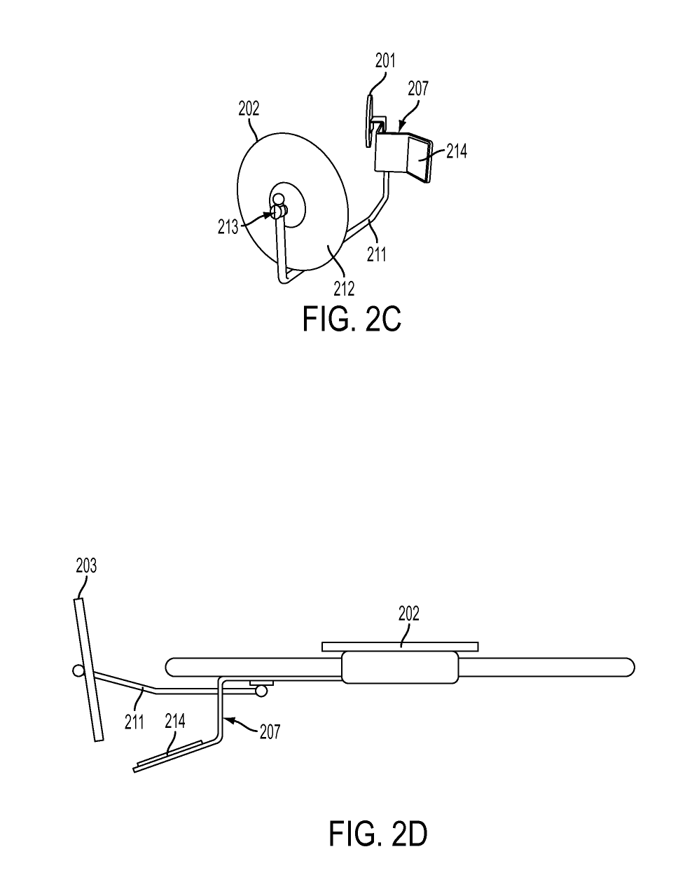

Referring now to FIGS. 2A through 2D, an exemplary embodiment of another system in accordance with the principles of the invention is shown generally. Referring to FIG. 2A, system 200 generally can include a communication device 206 and a virtualization apparatus 201 coupled to communication device 206. Virtualization apparatus 201 can include, for example, a front mirror 202 and/or a side mirror 203 along with associated components and features described and shown herein. A user can be positioned to face a front of system 200 and look into front mirror 202 and, directly or indirectly, side mirror 203. Opening 204 in front mirror 202 allows an optical sensor 205 of communication device 206 to view the contact lens user for display, recordation and/or transmission in real-time to the remote trainer or compliance monitor. Side mirror 203, depending upon its orientation, can reflect the user's image back toward the user and to a second optical sensor 218 (FIG. 2B) on the back of communication device 206 for display, recordation and/or transmission in real time to the remote trainer or compliance monitor. Reflective transmission to second optical sensor 218 can occur by way of a rear mirror 214 (FIGS. 2B, 2C and 2D.)

Front mirror 202 and side mirror 203 can be any convenient shape and size in accordance with the principles of the invention and, preferably, can be of a shape and size to view a user's eye and/or sufficient viewing of the user to view motions and movements associated with contact lens use and insertion. Rear mirror 214 can have various shapes and sizes in accordance with its purpose of reflectively coupling side mirror 203 to second optical sensor 218. Each of the mirrors 202, 203 and 214 can also, in any combination, have a shape including, but not limited to, round, square, rectangular, triangular, trapezoid, and pentagon. For instance, as illustrated in FIG. 2A, the front and side mirrors 202 and 203, respectively, are shown to have a round or circular shape and rear mirror 214 (FIG. 2B) is shown to have a square shape.

Front mirror 202 can have opening 204 therein that aligns with optical sensor 205 of a communication device 206. Opening 204 can be sized accordingly. Front mirror 202 can be mounted on device 206. As shown, front mirror 202 can be mounted on device 206 by a rear member 225, which can be a bracket or a clip. Front mirror 202 can be fixed to rear member 225. Rear member 225 can be removably attached to communication device 206 such that opening 204 aligns with communication device 206 optical sensor 205. Front mirror 202 and rear member 225 attached thereto can have varying sizes and lengths, and can encompass a portion, more than or less than a width of communication device 206.

Side mirror 203 can reflectively communicate between the contact lens user and second optical sensor 218, as will now be discussed, with respect to the attachment system. To attach side mirror 203 and rear mirror 214, a support member 207 can extend from rear member 225. Support member 207 can extend from a bottom portion, a top portion or a side portion of the rear member 225. Support member 207 can include a first portion 208, a second portion 209 and a third portion 210. First portion 208 can extend parallel to and along communication device 206 and second portion 209 can extend at an angle, for example, perpendicular, to and away from communication device 206. Alternatively, first portion 208 can extend perpendicular to and away from the communication device 206 and second portion 209 can extend parallel to and along the communication device 206. Third portion 210 can extend at an angle from second portion 209. Third portion 210 can be angled to allow for reflection between rear mirror 214 and a second optical sensor 218. Third portion 210 can be angled to allow for reflection between rear mirror 214 and side mirror 203. Third portion 210 can be angled to allow for reflection between rear mirror 214 and both side mirror 203 and second optical sensor 218 simultaneously allowing for a series of reflections between the contact lens user and second optical sensor 218, by way of side mirror 203 and rear mirror 214. Side mirror 203 can also be configured to reflect off front mirror 202 in accordance with the principles of the invention.

Regarding the first portion 208 of the support member 207, side mirror 203 can be indirectly attached thereto. The side mirror 203 can be attached to the first portion 208 of the support member 207 by an attachment member 211 having a first end and a second opposing end. The first end of the attachment member 211 can be attached to a side of the first portion 208 of the support member 207. As shown in FIG. 2C, the second opposing end of the attachment member 211 can be attached to a back 212 of side mirror 203. The first end and second opposing end of the attachment member 211 can be either directly mounted to their respective members or attached by a coupling member 213. The coupling member 213 can be at least one of a suction device, an adhesive device, or a magnet.

Regarding the second portion 209 of the support member 207, as more clearly illustrated in FIG. 2B, rear mirror 214 can be mounted or connected thereto. In a particular embodiment, the rear mirror 214 can be directly mounted to the second portion 209 of the support member 207. In an alternative embodiment, the rear mirror 214 can be connected to the second portion 209 of the support member 207 by a second attachment member (not shown). The second attachment member can have a first end and an opposing second end. The first end of the second attachment member can be attached to the second portion 209 of the support member 207. The second opposing end of the second attachment member can be attached to a back of the rear mirror 214. The first end and second opposing end of the second attachment member can be either directly mounted to their respective members or attached by a second coupling member (not shown). The second coupling member can be at least one of a suction device, an adhesive device, or a magnet.

Regarding front mirror 202, the placement thereof on top of a portion of communication device 206 can permit a user to view a front view of their eye relative to the contact lens. Regarding the placement of the side mirror 203, placement thereof can permit a user to view a side view of the eye relative to the contact lens. Alternatively and/or in addition to, placement of the side mirror 203 can be aligned to reflect upon the front mirror 202 and/or the user.

Regarding the placement of side mirror 203 relative to the rear mirror 214, each or any combination thereof can be fixed or adjustable. For instance, in a particular embodiment, the side mirror 203 can be adapted to adjust relative the rear mirror 214, which can be in a fixed position. In an alternative embodiment, the side mirror 203 can be in a fixed position and adapted to adjust relative to the rear mirror 214, which can be adjustable. In a further alternative embodiment, the side mirror 203 and rear mirror 214 can be adapted to adjust relative each other.

Regarding the placement of the rear mirror 214, placement thereof can be positioned relative to second optical sensor 218. For example, the rear mirror 214 can be a distance away from and directly in front of second optical sensor 218. Additionally, the rear mirror 214 can be angled to reflect upon the side mirror 203.

Regarding the magnification to the user, the mirrors 202, 203 and 214 can present the same or different amounts of magnification to the user. For example, the mirrors 202, 203 and 214 can all have a 1× magnification. Alternatively, for example, the front mirror 202 can have a magnification of 1×, whereas the side and rear mirror has a magnification of 10×. Additionally, any combination of the mirrors 202, 203 and 214 can be planar or curved in accordance with the principles of the invention.

FIG. 2D shows a top view of system 200 showing the relative exemplary angles of side mirror 203 and rear mirror 214.

According to another embodiment, the system for assisting a user in inserting a contact lens. The system can further include a stand to hold the communication device substantially upright. For example, referring to an exemplary embodiment of FIG. 2A, the stand 215 can include a holder 217. The holder 217 can extend upwardly from a base. The communication device 206 can be positioned in holder 217 so stand 215 can receive and hold the communication device 206 substantially upright.

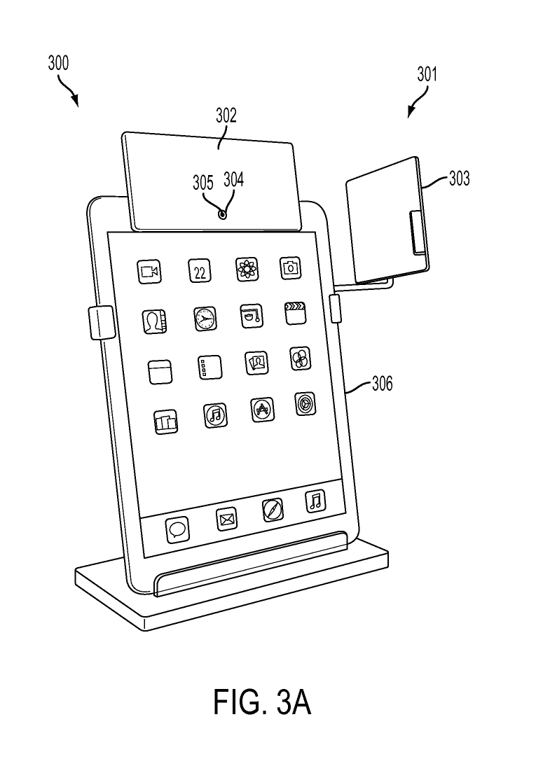

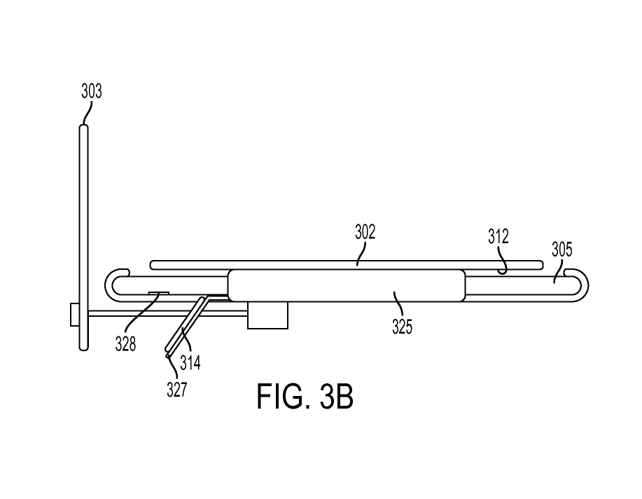

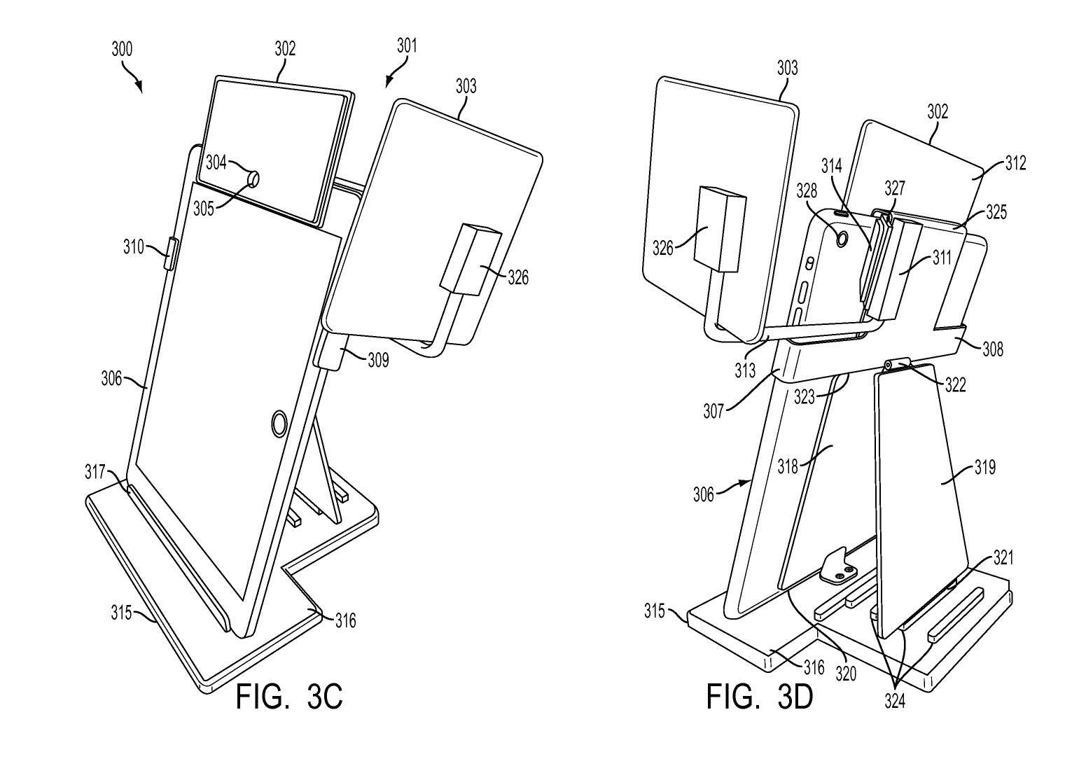

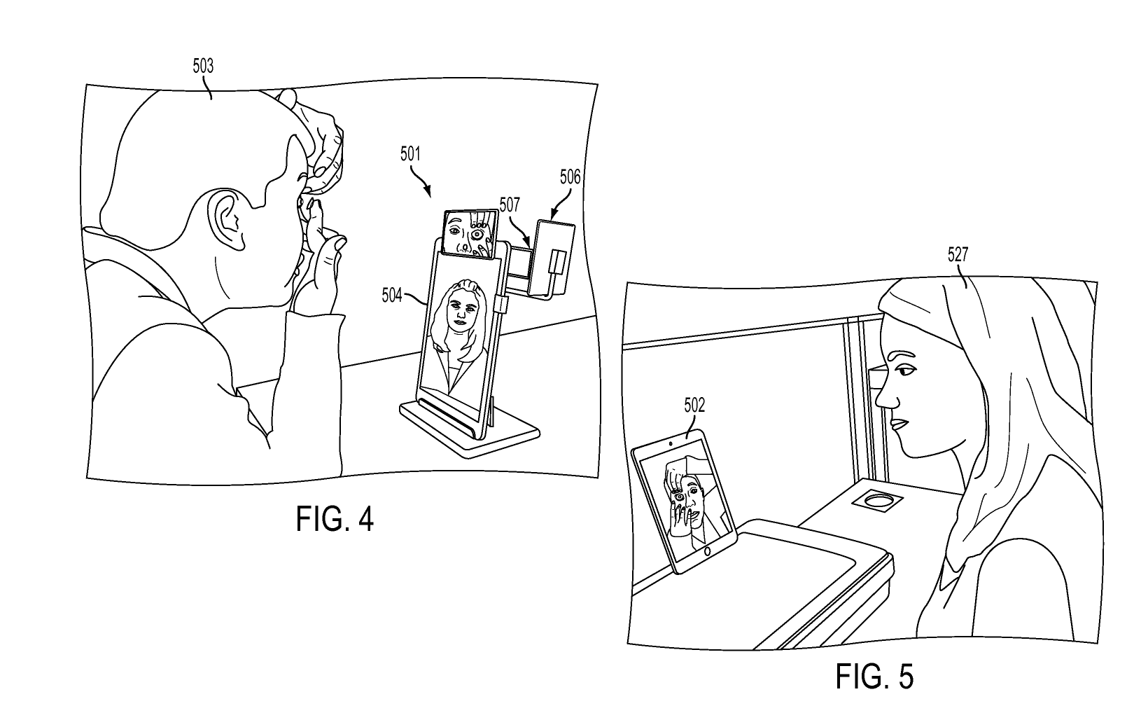

Referring now to FIG. 3A, an alternative exemplary embodiment of a system 300 with a virtualization apparatus generally shown at 301. The virtualization apparatus 301 includes a front mirror 302, a side mirror 303, and a rear mirror 314 (FIGS. 3B and 3D). The front mirror 302 has an opening 304 therein that aligns with an optical sensor 305 of a communication device 306.

Regarding the virtualization apparatus 301, as more clearly illustrated in FIG. 3D, the front mirror 302 has a back 312 with a rear member 325 mounted thereto. The rear member 325 can outwardly extend from the back 312 of the front mirror 302. The front mirror 302 through the rear member 325 removably attaches to a portion of a communication device 306 having an optical sensor 305. Upon attaching the front mirror 302 having the rear member 325 to the portion of the communication device 306 having the optical sensor 305, the opening 304 of the front mirror 302 aligns with the optical sensor 305 of the communication device 306. The front mirror 302 and the rear member 325 removably attached thereto can encompass a portion less than or equal to a width of the communication device 306 having the optical sensor 305.

The rear member 325 can further include at least a first arm 307 extending from a portion of the rear member 325. The portion can be a bottom, middle or a top of the rear member 325. The first arm 307 can include a first grasping member 309 to assist in receiving the communication device 306. The first grasping member 309 (FIG. 3C) can include at least one of a clasping device, a magnetic device, a clipping device, a suction device, or a gripping device.

In an alternate embodiment, the rear member 325 can include at least a first and second arm 307-308. The portion can be a bottom, middle, or a top of the rear member 325. The first and second arm 307-308 can extend from opposing ends of a portion of the rear member 325. The first and second arm 307-308 can each include a corresponding first and second grasping member 309-310 to assist in receiving the communication device 306. The first and second grasping members 309-310 can include at least one of a clasping device, a magnetic device, a clipping device, a suction device, or a gripping device.

To attach the side mirror 303, a first elongated support member 311 can be attached to an end of the rear member 325 to support an attachment member 313. The first elongated support member 311 can be placed vertically on a portion of the rear member 325. In a particular embodiment, the first elongated support member 311 can be placed on a top corner of the rear member 325. The first elongated support member 311 can be either mounted to the front end of the rear member 325 or attached by a coupling member (not shown). The coupling member can be a suction device, an adhesive device, and/or a magnet. The first elongated support member 311 can be placed either horizontally or vertically on a top portion, middle portion, or bottom portion on the end of the rear member 325. The first elongated support member 311 can include a portion for a first end of the attachment member 313 to attach thereto. A second opposing end of the attachment member 313 can project outwardly beyond the communication device 306. The second opposing end of the attachment member 313 can product outwardly beyond a front of the communication device 306. The second opposing end of the attachment member 313 can be attached to a back of a side mirror 303. The second opposing end of the attachment member 313 can be either directly attached to the side mirror 303 or attached by a second elongated support member 326. The second elongated support member 326 can be at least one of a suction device, an adhesive device or a magnet.

Further regarding the side mirror 303, such can be adapted to be placed substantially perpendicular to both the communication device 306 and the front mirror 302. In an alternate embodiment, the side mirror 303 can be angled relative to the user's eye. In a particular embodiment, the side mirror 303 can be either fixed or adjustable.

To attach the rear mirror 314, a rear portion 327 may extend out at an angle from the rear member 325 of the computing device. Rear portion 327 can be angled to allow for reflection between rear mirror 314 and a second optical sensor 328. Rear portion 327 can be angled to allow for reflection between the rear mirror 314 and both side mirror 303 and second optical sensor 328 simultaneously allowing for a series of reflections between the contact lens user and second optical sensor 328, by way of side mirror 303 and rear mirror 314.

Regarding the use of the front mirror 302, the placement thereof on top of a portion of communication device 306 can permit a user to view a front view of their eye relative to the contact lens. Regarding the use of the side mirror 303, placement thereof can permit a user to view a side view of the eye relative to the contact lens. Alternative, placement of the side mirror 303 can be aligned to reflect upon the front mirror 302 and/or the user.

Regarding the placement of side mirror 303 relative to rear mirror 314, each or any combination thereof can be fixed or adjustable. For instance, in a particular embodiment, the side mirror 303 can be adapted to adjust relative the rear mirror 314 being in a fixed position. In an alternative embodiment, the side mirror 303 can be in a fixed position and adapted to adjust relative to the rear mirror 314. In a further alternative embodiment, the side mirror 303 and rear mirror 314 can be adapted to adjust relative each other.

Regarding the placement of rear mirror 314, placement thereof can be positioned relative to a second optical sensor 328. For example, the rear mirror 214 can be a distance away from and directly in front of the second optical sensor 328. Additionally, the rear mirror 314 can be angled to reflect upon the side mirror 303.

Regarding the magnification to the user, front and side mirror 302 and 303 can present the same or different amounts of magnification to the user. For example, the front and side mirror 302 and 303 can both have a 1× magnification. Alternatively, for example, the front mirror 302 can have a magnification of 1×, whereas the side has a magnification of 10×.

Further regarding the front and side mirrors 302 and 303, each can be any convenient shape so long that it is larger than a user's eye. The front and side mirrors 302 and 303 can be any combination and any shape including, but not limited to, round, square, rectangular, triangular, trapezoid, and pentagon. For instance, as shown in the exemplary embodiment of FIG. 3A, the front mirror 302 can be rectangular by having the dimensions of 120 millimeters×60 millimeters and the side mirror 303 can be square by having dimensions of 60 millimeters×60 millimeters. The dimensions of the front and side mirrors 302 and 303 can be based on magnification of the mirror. Alternatively, the dimensions of the front and side mirror 302 and 303 can be determined in order for the user to precisely aim at a point of interest with respect to the eye. Rear mirror 314 can be of any suitable shape, size, and/or magnification.

According to an alternate embodiment, for example referring to the exemplary embodiment of FIG. 3C, the stand 315 can include at least a base 316, a holder 317, and a plurality of legs 318-319 (FIG. 3D). The holder 317 and the plurality of legs 318-319 can protrude upwardly from a top portion of the base 316. The communication device 306 can be placed between the holder 317 and the plurality of legs 318-319. The holder 317 can hold a front side of the communication device 306 and the plurality of legs 318-319 can hold a back side of the communication device 306. By such placement, the stand 315 can receive and hold the communication device 306 substantially upright.

The plurality of legs 318-319 can include at least a first leg 318 and a second leg 319. The first leg 318 can have a first leg end 320 securely fastened to the base 316 of the stand 315. The second leg 319 can have a second leg end 321 removably attached to the base 316 of the stand 315. The second leg end 321 can be removably attached from a plurality of slots 324 located on a top portion of the base 316. The first and second legs 318-319 of the stand 315 can be rotatable fastened at a joining point 322 that is opposite of the first and second leg end 320-321. The rear member 325 of the front mirror 302 can be placed on top of a top portion 323 of the first leg 318 to hold the communication device 306 substantially upright.

According to another embodiment, the system can permit feedback and guidance regarding inserting a contact lens through an output device. For example, as more clearly illustrated in FIGS. 4 and 5, a trainer 527 at a first communication device 502 can be connected to a user 503 at a second communication device 504. The trainer 527 can be displayed on an output device of the second communication device 504 of the user 503. Also, the user 503 can be displayed on an output device of the first communication device 502 of the trainer 527. As such, the trainer 527 can provide guidance in how the user 503 is to insert a contact lens. The trainer 527 can provide guidance before, while or after the user inputs a contact lens.

Regarding the display of the user 503 to the trainer 527 through the first communication device 502, a plurality of views of an eye of the user 503 may be displayed to the trainer 527 on the second communication device 504. For example, the trainer 527 may have at least a front view and a side view of the eye of the user 503. As illustrated in FIG. 4, the trainer 527 may have the same view as the user 503 when using the virtualization apparatus 501. In another embodiment, the trainer 527 may have a side view of the eye through a second optical sensor (not shown) on the back of the second communication device 504. The view through the second optical sensor reflects from a rear mirror 507 onto a side mirror 506 to a side view of the eye of the user. The trainer 527 may operatively switch between the front view and side view to provide better guidance to the user 503.

Regarding the guidance provided by the trainer 527, such can be provided by at least one of a visual cue, an audio cue and an instructional video. Additionally, the guidance provided the trainer 527 can be either live or pre-loaded. For instance, the user 503 can pre-record a video of how they should correctly insert the contact lens for later play. In alternative embodiment, a trainer can pre-record a video for the user to watch while inserting a contact lens. In a further alternative embodiment, a video can be played from the internet teaching the player how to insert a contact lens.

Regarding the view of the trainer, such can relate to a number of mirrors belonging to the virtualization apparatus. For example, in the embodiment illustrated in FIG. 4, utilizing the virtualization apparatus 501, the trainer 527 in FIG. 5 can have the same view as the user.

According to another embodiment, the system can record and store information regarding the user's insertion, wear and removal of contact lenses, and the appearance of the user's eyes at the time of insertion and/or removal. For example, rather than a trainer, the first communication device 502 may be associated with a compliance monitor or data collection entity, and the second communication device may record and transmit information concerning the user's insertion, wear and/or removal of contact lenses to the first communication device for review and/or collection and storage.

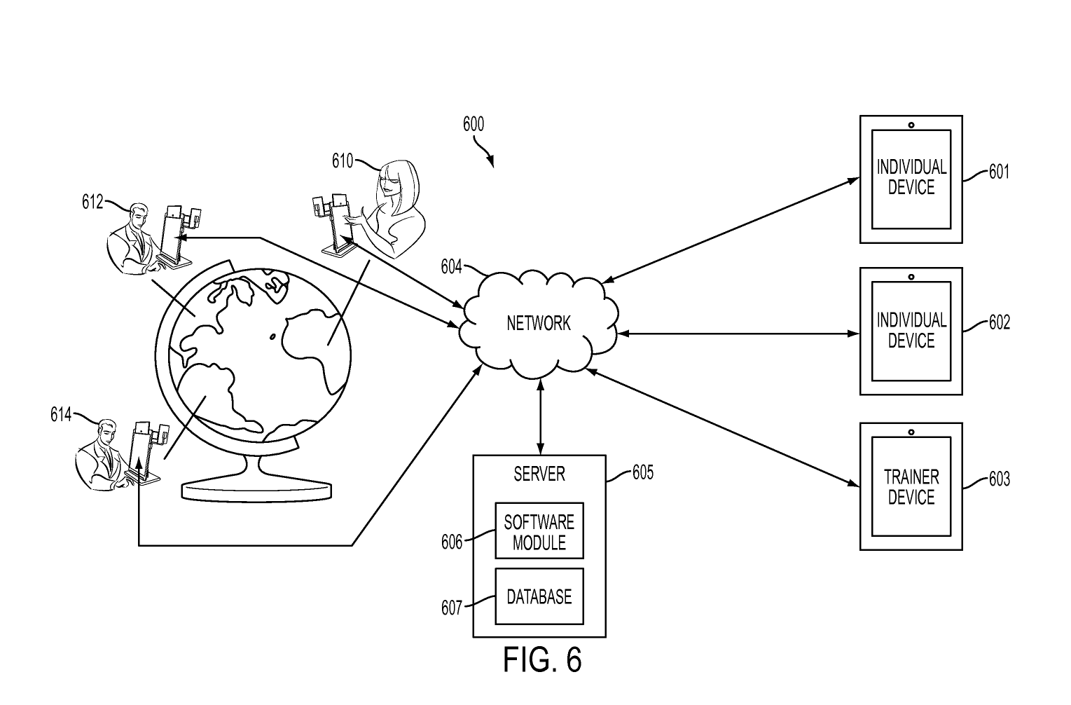

Referring now to FIG. 6, a diagram of an exemplary system 600 is shown in accordance with one or more embodiments illustrated above. System 600 can include one or more communication devices, e.g., individual communication devices 601-602 and trainer communication device 603, network 604, server 605, database 607, and software module 606. It is foreseen that any plurality of devices can be used according to various embodiments. For example, the plurality of communication devices can be a predetermined or identified number of communication devices. Contact lens user systems can be remotely located as shown with contact lens users 610, 612, and/or 614 utilizing the system in accordance with the principles of the invention. According to an embodiment, the one or more communication devices for contact lens users 610, 612, 614 and individual/trainer/compliance monitor communication devices 601, 602 and 603, can be configured to send and/or receive data to and through network 604 to assist in the contact lens user training or monitoring. For example, a trainer at training communication device 603 can send data to any number of communication devices, e.g. contact lens users 610, 612, and 614 communication devices. Conversely, a compliance monitor at communication device 603 can receive data and information from any number of communication devices 601, 602.

The one or more communication devices, e.g., individual communication devices 601-602 and trainer/compliance monitor communication device 603, can be any type of communication device, including a mobile telephone, a laptop, tablet, or desktop computer, a netbook, a video game device, a pager, a smart phone, an ultra-mobile personal computer (UMPC), a personal data assistant (PDA). The communication device can run one or more applications, such as Internet browsers, voice calls, video games, videoconferencing, and email, among others. The communication devices 601-603 can be coupled to a network and configured to send and/or receive data to the network.

Network 604 can provide network access, data transport and other services to the devices coupled to it in order to send/receive data from any number of user devices, as explained above. In general, network 604 can include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, network 604 can implement one or more of a GSM architecture, a General Packet Radio Service (GPRS) architecture, a Universal Mobile Telecommunications System (UMTS) architecture, and an evolution of UMTS referred to as Long Term Evolution (LTE). Network 604 can, again as an alternative or in conjunction with one or more of the above, implement a WiMAX architecture defined by the WiMAX forum. Network 604 can also comprise, for instance, a local area network (LAN), a wide area network (WAN), the Internet, a virtual LAN (VLAN), an enterprise LAN, a virtual private network (VPN), an enterprise IP network, or any combination thereof.

Server 605 can also be any type of communication device coupled to network 604, including but not limited to a personal computer, a server computer, a series of server computers, a mini computer, and a mainframe computer, or combinations thereof. Server 605 can be a web server (or a series of servers) running a network operating system, examples of which can include but are not limited to Microsoft Windows Server, Novell NetWare, or Linux. Server 605 can be used for and/or provide cloud and/or network computing. Although not shown in FIG. 6, server 605 can have connections to external systems like email, SMS messaging, text messaging, ad content providers, etc.

Database 607 can be any type of database, including a database managed by a database management system (DBMS). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, Adaptive Server Enterprise, FileMaker, Microsoft Access, Microsoft SQL Server, MySQL, PostgreSQL, and a NoSQL implementation. A DBMS typically includes a modeling language, data structure, database query language, and transaction mechanism. The modeling language is used to define the schema of each database in the DBMS, according to the database model, which can include a hierarchical model, network model, relational model, object model, or some other applicable known or convenient organization. Data structures can include fields, records, files, objects, and any other applicable known or convenient structures for storing data. A DBMS can also include metadata about the data that is stored.

Software module 606 can be a module that is configured to send, process, and receive information at server 605. Software module 606 can provide another mechanism for sending and receiving data at server 605 besides handling requests through web server functionalities. Software module 606 can send and receive information using any technique for sending and receiving information between processes or devices including but not limited to using a scripting language, a remote procedure call, an email, a tweet, an application programming interface, Simple Object Access Protocol (SOAP) methods, Common Object Request Broker Architecture (CORBA), HTTP (Hypertext Transfer Protocol), REST (Representational State Transfer), any interface for software components to communicate with each other, using any other known technique for sending information from a one device to another, or any combination thereof.

Although software module 606 can be described in relation to server 605, software module 606 can reside on any other device. Further, the functionality of software module 606 can be duplicated on, distributed across, and/or performed by one or more other devices, either in whole or in part.

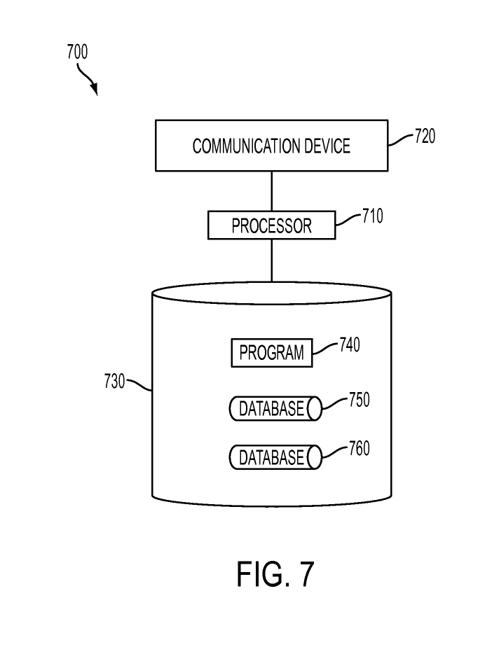

Referring now to FIG. 7, there is illustrated a schematic diagram of an exemplary controller 700 that may be utilized in accordance with the present invention. The exemplary controller 700 includes a processor 710, a communication device 720 and a data storage or memory component 730. The processor 710 is in communication with both the communication device 720 and the data storage device 730. The communication device 720 may be configured to communicate information via a communication channel, wired or wireless, to electronically transmit and receive digital data related to the functions discussed herein. The communication device 720 may also be used to communicate, for example, with one or more human readable display devices, such as, an LCD panel, an LED display or other display device or printer. The storage device 730 may comprise any appropriate information storage device, including combinations of magnetic storage devices (e.g., magnetic tape, radio frequency tags, and hard disk drives), optical storage devices, computer readable media, and/or semiconductor memory devices such as Random Access Memory (RAM) devices and Read-Only Memory (ROM) devices. The storage device 730 may store the program 740 for controlling the processor 710. The processor 710 performs instructions of the program 740, and thereby operates in accordance with the present invention. For example, the processor 710 may receive information relating to the contact lens users, trainers and other individuals supporting the contact lens user. The storage device 730 may also store and send all or some of the information sent to the processor 710 in one or more databases 750 and 760.

Communication device 720 may include an input device including any mechanism or combination of mechanisms that permit an operator to input information to communication device 720, such as a keyboard, a mouse, a touch sensitive display device, a microphone, a pen-based pointing device, a biometric input device, and/or a voice recognition device. Communication device 720 may include an output device that can include any mechanism or combination of mechanisms that outputs information to the operator, including a display, a printer, a speaker, etc.

According to an embodiment, the system and/or apparatus can be used in a method of training a user to insert a contact lens. For example, the method can include mounting a communication device onto a stand, attaching a virtualized apparatus onto a top portion of the communication device, and a trainer through a second communication device instructing the user to insert a contact lens. The user can utilize the virtualized apparatus to view varying angles of their eye with respect to the contact lens. The trainer can instruct the user while the user inserts the contact into their eye.

Numerous specific details have been set forth to provide a thorough understanding of the embodiments. It will be understood, however, that the embodiments can be practiced without these specific details. In other instances, well-known operations, components and circuits have not been described in detail so as not to obscure the embodiments. It can be appreciated that the specific structural and functional details are representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

It also is to be appreciated that the described embodiments illustrate exemplary implementations, and that the functional components and/or modules can be implemented in various other ways which are consistent with the described embodiments. Furthermore, the operations performed by such components or modules can be combined and/or separated for a given implementation and can be performed by a greater number or fewer number of components or modules.

While various exemplary embodiments have been described above, it should be understood that they have been presented by way of example only, and not limitation. Thus, the breadth and scope of the present disclosure should not be limited by any of the above-described exemplary embodiments.

Although the foregoing description is directed to the preferred embodiments of the invention, it is noted that other variations and modifications will be apparent to those skilled in the art, and can be made without departing from the spirit or scope of the invention. Moreover, features described in connection with one embodiment of the invention can be used in conjunction with other embodiments, even if not explicitly stated above.

What is claimed is:

1. A virtualization apparatus for assisting a user with contact lens usage, comprising:
a front mirror having an opening therein; and
a support member coupled to the front mirror,
wherein the front mirror by way of the support member is capable of being attached to a communication device, and
wherein the opening of the front mirror is adapted to be aligned with an optical sensor of the communication device.

2. The virtualization apparatus of claim 1, further comprising a side mirror coupled to the support member and being adapted for positioning beyond and alongside the communication device.

3. The virtualization apparatus of claim 2, wherein the side mirror is coupled to the support member by a support arm.

4. The virtualization apparatus of claim 3, wherein at least one of the support arm and the side mirror is adjustable.

5. The virtualization apparatus of claim 1, further comprising a side mirror adapted to be coupled to the communication device.

6. The virtualization apparatus of claim 5, further comprising a rear mirror adapted to be coupled to the communication device proximate a second optical sensor on the communication device, wherein the rear mirror is adapted to have a first reflective path between the rear mirror and the second optical sensor, and a second reflective path between the rear mirror and the side mirror.

7. The virtualization apparatus of claim 6, wherein the support member extends outwardly and has a portion adapted to support the rear mirror and the rear mirror is attached to the portion of the support member.

8. The virtualization apparatus of claim 1, further comprising a side mirror and a rear mirror coupled to the support member, wherein the side mirror and the rear mirror are angled to reflect upon each other.

9. The virtualization apparatus of claim 8, further comprising a rear optical sensor, wherein the side mirror and the rear mirror are adapted to be angled to reflectively communicate between the rear optical sensor and an object.

10. The virtualization apparatus of claim 5, further comprising a support stand adapted to support the communication device and the front and side mirrors in a position to reflect on an object, wherein the front mirror is adapted reflect a front view of the object and the side mirror is adapted to reflect a side view of the object, and
wherein the object includes a contact lens during usage and an insertion device to support usage of the contact lens.

11. The virtualization apparatus of claim 10, wherein contact lens usage includes insertion and removal of the contact lens.

12. A system for assisting a user with contact lens usage, comprising:
a virtualization apparatus including a front mirror having an opening therein and a rear member outwardly extending from a back of the front mirror;
a communication device including at least an output device, a processor, and an optical sensor; and
a stand configured to receive and hold the communication device substantially upright,
wherein the opening of the front mirror is adapted to be aligned with the optical sensor of the communication device and is adapted to be coupled to the communication device by the rear member, and
wherein the processor of the communication device is configured to instruct the user as to how to use the contact lens through the output device of the communication device.

13. The system of claim 12, wherein the processor is configured to communicate with a remotely located communication device and the processor is configured to instruct the user how to use the contact lens based upon at least input from the remote communication device.

14. The system of claim 12, further comprising an attachment member extending from the rear member, and an elongated member having a first end attached to a first portion of the attachment member and a second end attached to a side mirror, wherein the second end of the elongated member protrudes outwardly beyond the communication device.

15. The system of claim 14, further comprising a rear mirror attached a second portion of the attachment member.

16. The system of claim 15, wherein the side mirror and the rear mirror are adapted to reflect upon each other.

17. The system of claim 12, further comprising an elongated attachment member fixed to an exterior of the rear member, an attachment member having a first end and an opposing second end, wherein the first end is fixed to the bottom portion of the elongated member, and a side mirror attached to the second end of the attachment member and extending beyond the communication device.

18. The system of claim 12, wherein the rear member includes at least a first arm and an opposing second arm, wherein the first arm and the opposing second arm extend from a bottom portion of the rear member, and each clip on to a respective front side and second side of the communication device.

19. The system of claim 12, wherein the processor of the communication device is configured to instruct through at least one of a visual cue, an audio cue and an instructional video.

20. The system of claim 12, further comprising a second communication device transmitting instructions to the communication device.

21. A system for assisting a contact lens wearer with contact lens usage, comprising:
a user communication device including an output device, a processor, and an optical sensor; and
a virtualization apparatus coupled to the user communication device, the virtualization apparatus including a front mirror including an opening, wherein the front mirror is coupled to the user communication device with the front mirror opening adapted for alignment with the optical sensor, whereby the front mirror and the optical sensor are directed in a direction toward the contact lens user and an image on the front mirror is substantially the same image sensed by the optical sensor,
wherein the processor is configured to communicate with a remote communication device and the processor is configured to communicate the image to the remote communication device and configured to receive instructions from the remote communication device regarding contact lens usage.

22. A system according to claim 21, further comprising a side mirror adapted to be coupled to the user communication device having a second sensor, wherein the side mirror is adapted to be in reflective communication with the second sensor.

23. A system according to claim 22, wherein the processor is configured to communicate information from the second sensor to the remote communication device.

24. A system according to claim 22, further comprising a back mirror adapted to be in reflective communication with the side mirror and the second sensor.

25. A system according to claim 21, wherein the output device is a display device and the image is displayed on the display device.

26. A system according to claim 21, wherein the image is a video image.

27. A system according to claim 21, wherein the processor is configured to transmit the image to the remote communication device.

28. A system for monitoring a user's contact lens usage comprising:
a virtualization apparatus including a front mirror having an opening therein and a rear member outwardly extending from a back of the front mirror;
a communication device including at least an output device, a processor, and an optical sensor; and
a stand configured to receive and hold the communication device substantially upright,
wherein the opening of the front mirror is adapted to be aligned with the optical sensor of the communication device and is adapted to be coupled to the communication device by the rear member, and
wherein the processor of the communication device is configured to record and transmit information about the user's contact lens usage through the output device of the communication device.

29. The system of claim 28, wherein the processor is configured to communicate with a remotely located communication device.
